(19) United States
(12) Patent Application Publication
(10) Pub. No.: US 2015/0117447 A1
(43) Pub. Date: Apr. 30, 2015

(54) TERMINAL DEVICE FOR BROADCASTING AND COMMUNICATION, AND METHOD FOR PROCESSING PACKET THEREOF

(71) Applicant: Electronics and Telecommunications Research Institute, Daejeon (KR)

(72) Inventors: Woo-Suk KIM, Gyeryong-si (KR); Byungjun BAE, Daejeon (KR); Hun Hee LEE, Daejeon (KR); Kyu Tae YANG, Daejeon (KR); Hyoungsoo LIM, Daejeon (KR); Namho HUR, Daejeon (KR)

(21) Appl. No.: 14/303,689

(22) Filed: Jun. 13, 2014

(30) Foreign Application Priority Data
Oct. 30, 2013 (KR) 10-2013-0130547

(51) Int. Cl. H04L 12/18

(52) U.S. Cl. CPC H04L 12/18
USPC 370/390

(57) ABSTRACT

A terminal device for broadcasting and communication creates a virtual network interface, connects the virtual network interface and a communicating unit of the terminal device for broadcasting and communication to each other, connects the virtual network interface and a broadcasting receiver of the terminal device for broadcasting and communication to each other, activates the virtual network interface, and processes transmitted and received packets via a broadcasting network and a communication network through the virtual network interface.

### CROSS-REFERENCE TO RELATED APPLICATION

This application claims priority to and the benefit of Korean Patent Application No. 10-2013-0130547 filed in the Korean Intellectual Property Office on Oct. 30, 2013, the entire contents of which are incorporated herein by reference.

### BACKGROUND OF THE INVENTION

(a) Field of the Invention

The present invention relates to a terminal device for broadcasting and communication, and a method for processing a packet thereof, and more particularly, to a technology of combining a broadcasting receiving apparatus and a communicating apparatus included in a user terminal to each other and using the combined broadcasting receiving apparatus and communicating apparatus as one virtual network interface apparatus in a broadcasting and communication convergence environment in which a broadcasting network and a communication network interwork with each other.

(b) Description of the Related Art

In a broadcasting and communication convergence environment in which a broadcasting network and a communication network interwork and are serviced with each other, a user terminal includes both a broadcasting receiving apparatus and a communicating apparatus, and a broadcasting and communication convergence service is constructed by simultaneously or selectively using the broadcasting receiving apparatus and the communicating apparatus in an application layer. For example, an application program such as smart digital multimedia broadcasting (DMB) has implemented a broadcasting service through a terrestrial DMB (T-DMB) receiving apparatus and a data service interworking with the broadcasting service through a communication network (LTE, 3G, Wi-Fi, or the like).

One of the problems occurring in this situation is that the broadcasting receiving apparatus and the communicating apparatus that are technically different from each other should be individually controlled at the time of implementing the application program. This increases complexity of the application program to cause an increase in a time and a cost required for developing the application program, which hinders various broadcasting and communication convergence services from being rapidly introduced. When the broadcasting receiving apparatus and the communicating apparatus are combined to each other and used as one network apparatus, complexity in implementing the broadcasting and communication convergence service in the application layer may be decreased.

As the related art, there are technologies of combining a plurality of communicating apparatuses to each other as one apparatus such as an interface bonding technology by Linux. The plurality of communicating apparatuses are combined to each other, such that when a data rate is increased or any one communicating apparatus may not be used, another communicating apparatus is used, thereby making it possible to increase stability of communication. One of the main features of this technology is to allow the plurality of communicating apparatuses to be combined to each other and to be used as one virtual network interface apparatus. Therefore, the application program need not individually control the plurality of communicating apparatuses, and application programs designed without considering the plurality of communicating apparatuses may also be used without being modified.

However, the broadcasting receiving apparatus and the communicating apparatus are operated in technically different schemes. In order to combine the broadcasting receiving apparatus and the communicating apparatus operated in different schemes, a method that is different from a method according to the related art is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a terminal device for broadcasting and communication and a method for processing a packet thereof having advantages of decreasing complexity in implementing a broadcasting and communication convergence service in an application layer of a user terminal.

An exemplary embodiment of the present invention provides a terminal device for broadcasting and communication. The terminal device for broadcasting and communication includes a broadcasting receiver, a communicating unit, a virtual network interface, and a controller. The broadcasting receiver receives a broadcasting stream. The communicating unit performs Internet protocol (IP) communication. The virtual network interface combines the broadcasting receiver and the communicating unit to each other. The controller creates the virtual network interface, activates the virtual network interface, and stores broadcasting configuration information received through the broadcasting receiver in an address database.

The virtual network interface may include a packet transport controller processing a transmitted packet from an upper layer and received packets received through the broadcasting receiver and the communicating unit.

The packet transport controller may control the broadcasting receiver to receive a packet of a multicast address included in the broadcasting configuration information in the case in which the transmitted packet is the packet of the multicast address and is a join packet requesting to join in an IP multicast session received by the broadcasting receiver.

The packet transport controller may control the broadcasting receiver to stop receiving a packet of a multicast address included in the broadcasting configuration information in the case in which the transmitted packet is the packet of the multicast address and is a leave packet requesting to leave from an IP multicast session received by the broadcasting receiver.

The packet transport controller may transport the transmitted packet to the communicating unit in the case in which the transmitted packet is not a packet of a multicast address included in the broadcasting configuration information.

The packet transport controller may confirm whether the transmitted packet is the packet of the multicast address included in the broadcasting configuration information with reference to the address database.

The packet transport controller may transport the packets received through the broadcasting receiver and the communicating unit, respectively, to the upper layer.

Another exemplary embodiment of the present invention provides a method for processing transmitted and received packets by a terminal device for broadcasting and communication. The method for processing transmitted and received packets includes: receiving broadcasting configuration information through a broadcasting receiver of the terminal device for broadcasting and communication; creating a virtual network interface; connecting the virtual network interface and a communicating unit of the terminal device for broadcasting and communication to each other; connecting the virtual network interface and the broadcasting receiver to each other; activating the virtual network interface; and processing the transmitted and received packets through the virtual network interface.

The processing may include: receiving the transmitted packet from an upper layer; confirming whether the transmitted packet is a packet of a multicast address included in the broadcasting configuration information; controlling the broadcasting receiver to receive the packet of the multicast address in the case in which the transmitted packet is a join packet requesting to join in an IP multicast session received by the broadcasting receiver; and controlling the broadcasting receiver to stop receiving the packet of the multicast address in the case in which the transmitted packet is a leave packet requesting to leave from the IP multicast session received by the broadcasting receiver.

The processing may further include transporting the transmitted packet to the communicating unit in the case in which the transmitted packet is not the packet of the multicast address included in the broadcasting configuration information.

The receiving of the broadcasting configuration information may include storing a multicast address of a data stream configuring broadcasting from the broadcasting configuration information in an address database, and the confirming may include confirming whether a multicast address of the transmitted packet is present in the address database with reference to the address database.

### BRIEF DESCRIPTION OF THE DRAWINGS

FIG. 1 is a drawing showing a terminal device for broadcasting and communication according to an exemplary embodiment of the present invention.

FIG. 2 is a drawing showing an example of a method for creating a virtual network interface by a controller shown in FIG. 1.

FIG. 3 is a drawing schematically showing a virtual network interface according to an exemplary embodiment of the present invention.

FIG. 4 is a flowchart showing a method for processing a transmitted packet by the virtual network interface shown in FIG. 3.

FIG. 5 is a flowchart showing a method for processing a received packet by a virtual network interface according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Hereinafter, a terminal device for broadcasting and communication and a method for processing a packet thereof according to an exemplary embodiment of the present invention will be described in detail with reference to the accompanying drawings.

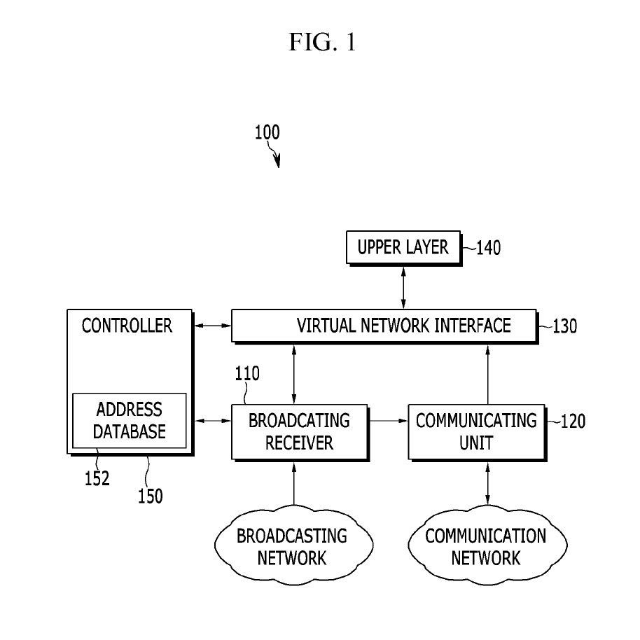

FIG. 1 is a drawing showing a terminal device for broadcasting and communication according to an exemplary embodiment of the present invention.

Referring to FIG. 1, a terminal device 100 for broadcasting and communication is a user terminal and includes a broadcasting receiver 110, a communicating unit 120, a virtual network interface 130, an upper layer 140, and a controller 150.

The broadcasting receiver 110, which is an apparatus implementing unidirectional one-to-many broadcasting communication, receives an internet protocol (IP) multicast type of broadcasting stream.

The communicating unit 120 and the virtual network interface 130, which are apparatuses (e.g., Ethernet apparatus) implementing general IP communication, implement general bidirectional one-to-one or one-to-many communication.

The virtual network interface 130 combines the broadcasting receiver 110 and the communicating unit 120 to each other.

The upper layer 140 includes an application, wherein the application uses the broadcasting receiver 110 and the communicating unit 120 through the virtual network interface 130.

The controller 150 creates the virtual network interface 130, activates the virtual network interface 130, and stores address information on a data stream configuring broadcasting in an address database 152 so as to be referenced by the virtual network interface 130.

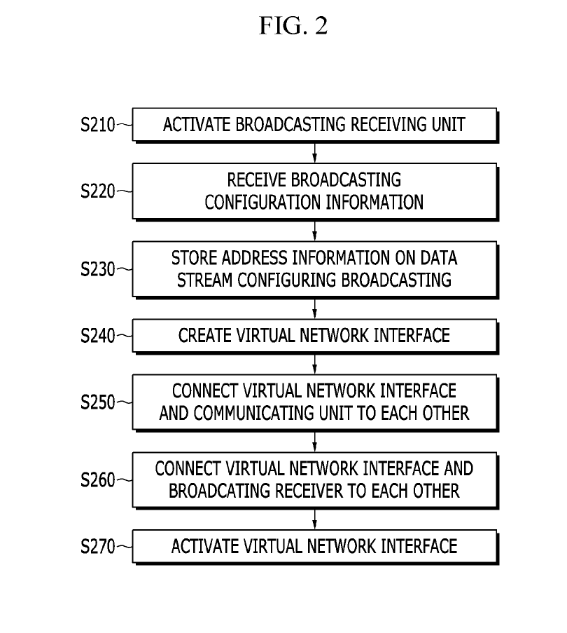

FIG. 2 is a drawing showing an example of a method for creating a virtual network interface by a controller shown in FIG. 1.

Referring to FIG. 2, the controller 150 receives broadcasting configuration information through the broadcasting receiver 110 (S220) after the broadcasting receiver 110 is activated (S210). The broadcasting configuration information may include address (or identifier) information (for example, a multicast address and a port number) capable of identifying each data stream (video, audio, or data) currently configuring a broadcasting service.

The controller 150 stores the address information on the data stream configuring broadcasting in an address database 152 (S230).

The controller 150 creates the virtual network interface 130 (S240), and connects the virtual network interface 130 and the communicating unit 120 to each other (S250). The virtual network interface 130 and the communicating unit 120 may be connected to each other using tunneling or network address translation (NAT), or the like, or may be connected to each other by other methods.

After the virtual network interface 130 and the communicating unit 120 are connected to each other, the controller 150 connects the broadcasting receiver 110 to the virtual network interface 130 (S260).

As described above, after the broadcasting receiver 110 and the virtual network interface 130 are connected to each other, an IP multicast packet received by the broadcasting receiver 110 is transported to the upper layer 140 through the virtual network interface 130.

After the communicating unit 120 and the broadcasting receiver 110 are connected to the virtual network interface 130, the controller 150 activates the virtual network interface 130 (S270). The virtual network interface 130 is activated under control of the controller 150 and is in a state in which it may be used by the terminal device 100 for broadcasting and communication and the application of the upper layer 140.

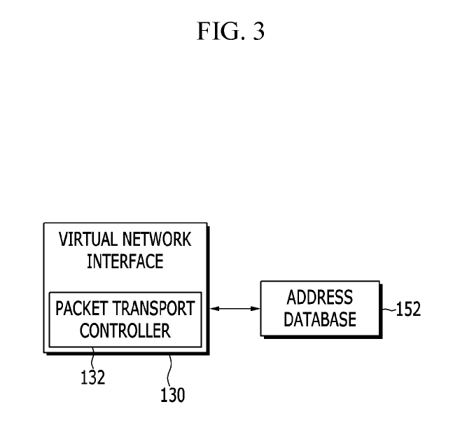

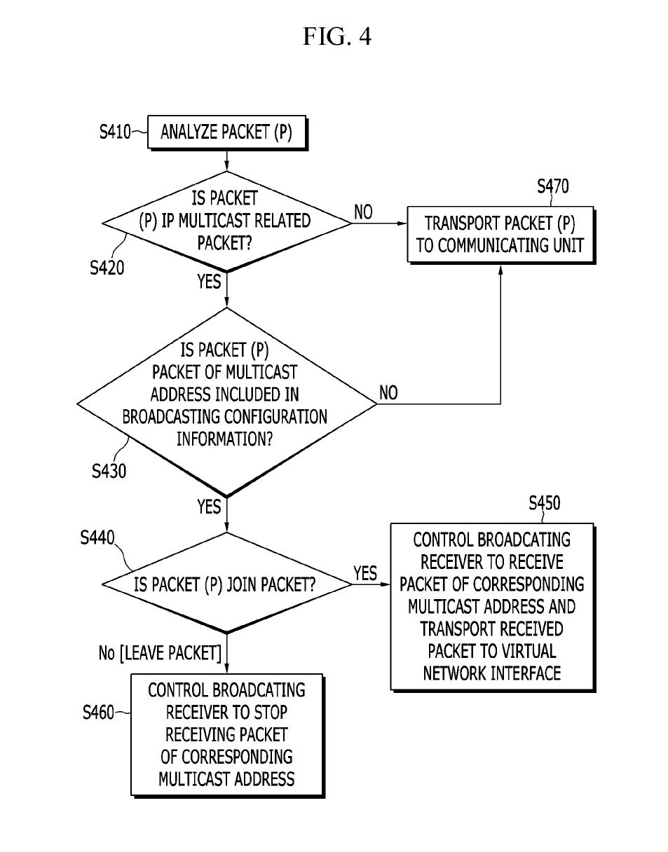

FIG. 3 is a drawing schematically showing a virtual network interface according to an exemplary embodiment of the present invention, and FIG. 4 is a flowchart showing a method for processing a transmitted packet by the virtual network interface shown in FIG. 3.

Referring to FIG. 3, the virtual network interface 130 may include a packet transport controller 132.

Since the broadcasting receiver 110 does not generally have a transmission function, all transmitted packets generated by the application are transmitted through the communicating unit 120. However, IGMP or ICMPv6 packets generated in a join process in order to receive the IP multicast should be processed differently.

Referring to FIG. 4, when the packet transport controller 132 receives a packet (P) to be transmitted from the application of the upper layer, it analyzes the received packet (P) (S410).

The packet transport controller 132 confirms whether the packet (P) is an IP multicast related packet (S420).

In the case in which the packet (P) is the IP multicast related packet, the packet transport controller 132 confirms whether the packet (P) is a packet of the multicast address included in the broadcasting configuration information with reference to the address database 152 (S430).

In the case in which the packet (P) is the packet of the multicast address included in the broadcasting configuration information, the packet transport controller 132 confirms whether the packet (P) is a join packet requesting to join in an IP multicast session received by the broadcasting receiver 110 or a leave packet requesting to leave from the IP multicast session (S440).

In the case in which the packet (P) is the join packet, the packet transport controller 132 controls the broadcasting receiver 110 to receive a packet of a corresponding IP multicast address and transport the received packet to the virtual network interface 130 (S450), and does not actually transport the packet (P).

Further, in the case in which the packet (P) is the leave packet, the packet transport controller 132 controls the broadcasting receiver 110 to stop receiving the packet of the corresponding IP multicast address (S460), and does not actually transport the packet (P).

Meanwhile, in the case in which the packet (P) is not the IP multicast related packet or is not related to the IP multicast address included in the broadcasting configuration information, the packet transport controller 132 transports the packet (P) to the communicating unit 120 (S470).

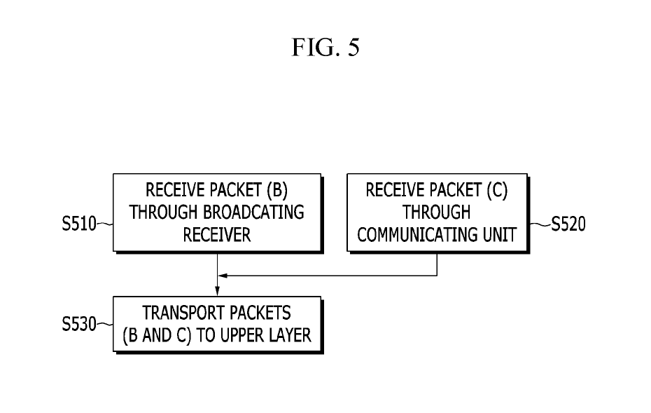

FIG. 5 is a flowchart showing a method for processing a received packet by a virtual network interface according to an exemplary embodiment of the present invention.

Referring to FIG. 5, when the broadcasting receiver 110 and the communicating unit 120 receive a packet (B) and a packet (C), respectively, they transport the packet (B) and the packet (C) to the virtual network interface 130, respectively.

When the packet transport controller 132 of the virtual network interface 130 receives the packet (B) and the packet (C) through the broadcasting receiver 110 and the communicating unit 120, respectively (S510 and S520), the packet transport controller 132 of the virtual network interface 130 transports the received packet (B) and packet (C) to the upper layer 140 (S530). In this case, it is assumed that addresses of IP multicast packets received through the broadcasting receiver 110 and the communicating unit 120 are not overlapped with each other. Therefore, the packet transport controller 132 may transport the packets (B and C) received through the broadcasting receiver 110 and the communicating unit 120, respectively, to the upper layer 140 without performing a separate processing process for distinguishing between the packets (B and C) received through the broadcasting receiver 110 and the communicating unit 120, respectively.

According to an exemplary embodiment of the present invention, a broadcasting receiving apparatus and a communicating apparatus of a user terminal are combined to each other and are used as one virtual network interface apparatus, such that an application program configuring a broadcasting and communication convergence service in an application layer of the user terminal may access a broadcasting and communication service as if it uses one network interface apparatus. Therefore, the broadcasting and communication convergence service may be implemented with decreased complexity.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal device for broadcasting and communication, comprising:
a broadcasting receiver receiving a broadcasting stream;
a communicating unit performing Internet protocol (IP) communication;
a virtual network interface combining the broadcasting receiver and the communicating unit to each other; and
a controller creating the virtual network interface, activating the virtual network interface, and storing broadcasting configuration information received through the broadcasting receiver in an address database.

2. The terminal device for broadcasting and communication of claim 1, wherein
the virtual network interface includes a packet transport controller processing a transmitted packet from an upper layer and received packets received through the broadcasting receiver and the communicating unit.

3. The terminal device for broadcasting and communication of claim 2, wherein
the packet transport controller controls the broadcasting receiver to receive a packet of a multicast address included in the broadcasting configuration information in the case in which the transmitted packet is the packet of the multicast address and is a join packet requesting to join in an IP multicast session received by the broadcasting receiver.

4. The terminal device for broadcasting and communication of claim 2, wherein
the packet transport controller controls the broadcasting receiver to stop receiving a packet of a multicast address included in the broadcasting configuration information in the case in which the transmitted packet is the packet of the multicast address and is a leave packet requesting to leave from an IP multicast session received by the broadcasting receiver.

5. The terminal device for broadcasting and communication of claim 2, wherein
the packet transport controller transports the transmitted packet to the communicating unit in the case in which the transmitted packet is not a packet of a multicast address included in the broadcasting configuration information.

6. The terminal device for broadcasting and communication of claim 5, wherein
the packet transport controller confirms whether the transmitted packet is the packet of the multicast address included in the broadcasting configuration information with reference to the address database.

7. The terminal device for broadcasting and communication of claim 2, wherein
the packet transport controller transports the packets received through the broadcasting receiver and the communicating unit, respectively, to the upper layer.

8. A method for processing transmitted and received packets by a terminal device for broadcasting and communication, comprising:
receiving broadcasting configuration information through a broadcasting receiver of the terminal device for broadcasting and communication;
creating a virtual network interface;
connecting the virtual network interface and a communicating unit of the terminal device for broadcasting and communication to each other;
connecting the virtual network interface and the broadcasting receiver to each other;
activating the virtual network interface; and
processing the transmitted and received packets through the virtual network interface.

9. The method for processing transmitted and received packets of claim 8, wherein
the processing includes:
receiving the transmitted packet from an upper layer;
confirming whether the transmitted packet is a packet of a multicast address included in the broadcasting configuration information;
controlling the broadcasting receiver to receive the packet of the multicast address in the case in which the transmitted packet is a join packet requesting to join in an IP multicast session received by the broadcasting receiver; and
controlling the broadcasting receiver to stop receiving the packet of the multicast address in the case in which the transmitted packet is a leave packet requesting to leave from the IP multicast session received by the broadcasting receiver.

10. The method for processing transmitted and received packets of claim 9, wherein
the processing further includes transporting the transmitted packet to the communicating unit in the case in which the transmitted packet is not the packet of the multicast address included in the broadcasting configuration information.

11. The method for processing transmitted and received packets of claim 9, wherein
the receiving of the broadcasting configuration information includes storing a multicast address of a data stream configuring broadcasting from the broadcasting configuration information in an address database, and
the confirming includes confirming whether a multicast address of the transmitted packet is present in the address database with reference to the address database.

12. The method for processing transmitted and received packets of claim 8, wherein
the processing includes transporting packets received through the broadcasting receiver and the communicating unit, respectively, to an upper layer.
